(19) United States
(12) Patent Application Publication
(10) Pub. No.: US 2009/0018235 A1
(43) Pub. Date: Jan. 15, 2009

(54) ENVIRONMENTALLY DEGRADABLE POLYMERIC COMPOSITION AND PROCESS FOR OBTAINING AN ENVIRONMENTALLY DEGRADABLE POLYMERIC COMPOSITION

(75) Inventors: Jefter Fernandes Nascimento, Sao Paulo City (BR); Wagner Mauricio Pachekoski, Sao Carlos (BR); Jose Augusto Marcondes Agnelli, Sao Carlos (BR)

Correspondence Address: DARBY & DARBY P.C., P.O. BOX 770, Church Street Station, New York, NY, 10008-0770, US

(73) Assignee: PHB INDUSTRIAL S.A., Serrana - SP (BR)

(21) Appl. No.: 12/280,395

(22) PCT Filed: Feb. 23, 2007
(86) PCT No.: PCT/BR07/00045

§ 371 Date: Aug. 22, 2008

(30) Foreign Application Priority Data
Feb. 24, 2006 (BR) PI0600683-3

(51) Int. Cl. C08K 11/00; C08G 63/06; C08K 3/10; C08K 5/09; C08K 5/17

(52) U.S. Cl. 523/128; 525/450; 524/413; 524/322; 524/236; 524/400

(57) ABSTRACT

The present invention refers to a polymeric composition prepared from a biodegradable polymer defined by poly-hydroxybutyrate (PHB) or copolymers thereof, and at least one other biodegradable polymer, such as polycaprolactone (PCL) and poly (lactic acid) (PLA), so as to alter its structure, and further at least one additive of the type of natural filler and natural fibers, and, optionally, nucleant, thermal stabilizer, processing aid, with the object of preparing an environmentally degradable material. According to the production process described herein, the composition resulting from the mixture of the modified biodegradable polymer and additives can be utilized in the manufacture of injected packages for food products, injected packages for cosmetics, tubes, technical pieces and several injected products.

### FIELD OF THE INVENTION

The present invention refers to a polymeric composition prepared from a biodegradable polymer defined by polyhydroxybutyrate (PHB) or copolymers thereof, and at least one other biodegradable polymer, such as polycaprolactone (PCL), and poly (lactic acid) (PLA), so as to alter its structure, and also at least one additive of the type of natural fillers and natural fibers, and optionally, nucleant, thermal stabilizer, processing aid, with the object to prepare an environmentally degradable material.

According to the process described herein, the composition resulting from the mixture of the biodegradable polymer modified and additives, can be utilized in the manufacture of injected packages for food, injected packages for cosmetics, tubes, technical pieces and several injected products.

### PRIOR ART

There are known from the prior art different biodegradable polymeric materials utilized to manufacture garbage bags and/or packages, comprising a combination of degradable synthetic polymers and additives, so as to improve their production and/or their properties, ensuring a wide application.

Polymeric compound is any composition with one or more polymers with modifying additives, the latter being present in an expressive quantity.

Polymeric compounds known by the prior art reveal a large quantity of compounds consisting of countless types of polymers reinforced with different types of fibers, as for example, fiber glass, carbon fibers and natural fibers, or loaded with countless types of fillers, as for example, talc and calcium carbonate.

There are widely known from the prior art the polymeric compounds consisting of conventional thermoplastics reinforced with fiber glass, which has recently been employed in several highly commercially significant applications. This is occurring mainly because such compounds have advantages such as low prices, corrosion resistance, adequate mechanical performance and recycling facility. One typical example of such materials is a compound of polypropylene reinforced with fiber glass.

On the other hand, there are few records regarding modification of the biodegradable Poly (hydroxybutyrate)-PHB polymer. These modifications were carried out in laboratory processes and/or utilizing manual molding techniques with no industrial productivity. Usually, the rare processes for obtaining polymeric compounds formed by the PHB and by natural modifiers are carried out by compression molding, which considerably limits the shape of the product and, accordingly, its commercial application. The process of compression molding allows only the manufacture of products with limited structure and shape, considerably restricting the applications of these polymeric compounds.

There were not found records about compositions based on the PHB biodegradable polymer, including the two main objects of the present invention: the technology for obtaining PHB biodegradable polymer compositions containing countless natural modifiers, incorporated in several content ranges, including high contents of natural modifiers; the utilization of two commercially viable methods: the extrusion process for the obtention of the polymeric compounds and the injection molding for obtaining the products.

### SUMMARY OF THE INVENTION

It is a generic object of the present invention to provide a polymeric composition to be utilized in different applications, as for example, in the manufacture of injected packages for food, injected packages for cosmetics, tubes, technical pieces and several injected products, by using a biodegradable polymer defined by polyhydroxybutyrate or copolymers thereof; at least one other biodegradable polymer, and at least one additive thus way allowing the obtention of environmentally degradable materials.

According to a first aspect of the invention, there is provided a polymeric composition, comprising a biodegradable polymer defined by poly(hydroxybutyrate) or copolymers thereof; at least one additional polymer, such as poly (butylene adipate/butylene terephthalate), polycaprolactone and poly (lactic acid); and, optionally, at least one additive defined by: plasticizer of natural origin, such as natural fibers; natural fillers; thermal stabilizer; nucleant; compatibilizer; surface treatment agent; and processing aid.

According to a second aspect of the present invention, there is provided a method for preparing the environmentally degradable polymeric composition described above and that comprises the steps of:

a) pre-mixing the materials that constitute the composition of interest for uniformizing the length of the natural fibers, surface treatment of the natural fibers and/or natural fillers;

b) drying said pre-mixed materials and extruding the same, so as to obtain granulation thereof; and

c) injection molding the extruded and granulated material, for manufacture of several products.

### BRIEF DESCRIPTION OF THE DRAWINGS

FIG. 1 schematically represents a longitudinal sectional view of an extruder designed to prepare the PHB/natural modifiers compounds;

FIG. 1a illustrates an enlarged view of the conventional screw element indicated by the arrow in FIG. 1;

FIG. 1b illustrates an enlarged view of the shearing element indicated by the arrow in FIG. 1;

FIG. 1c illustrates an enlarged view of the left-hand pitch shearing element, indicated by the arrow in FIG. 1;

FIG. 1d illustrates an enlarged view of the high shearing element, indicated by the arrow in FIG. 1; and

FIG. 1e illustrates an enlarged view of the conventional left-hand pitch screw element, indicated by the arrow in FIG. 1.

### DETAILED DESCRIPTION OF THE INVENTION

Within the class of the biodegradable polymers, the structures containing ester functional groups are of remarkable interest, mainly due to their usual biodegradability and versatility in physical, chemical and biological properties. Produced by a large variety of microorganisms as source of energy and carbon, the polyalkanoates (polyesters derived from carboxylic acids) can be synthesized either by biological fermentation or chemically.

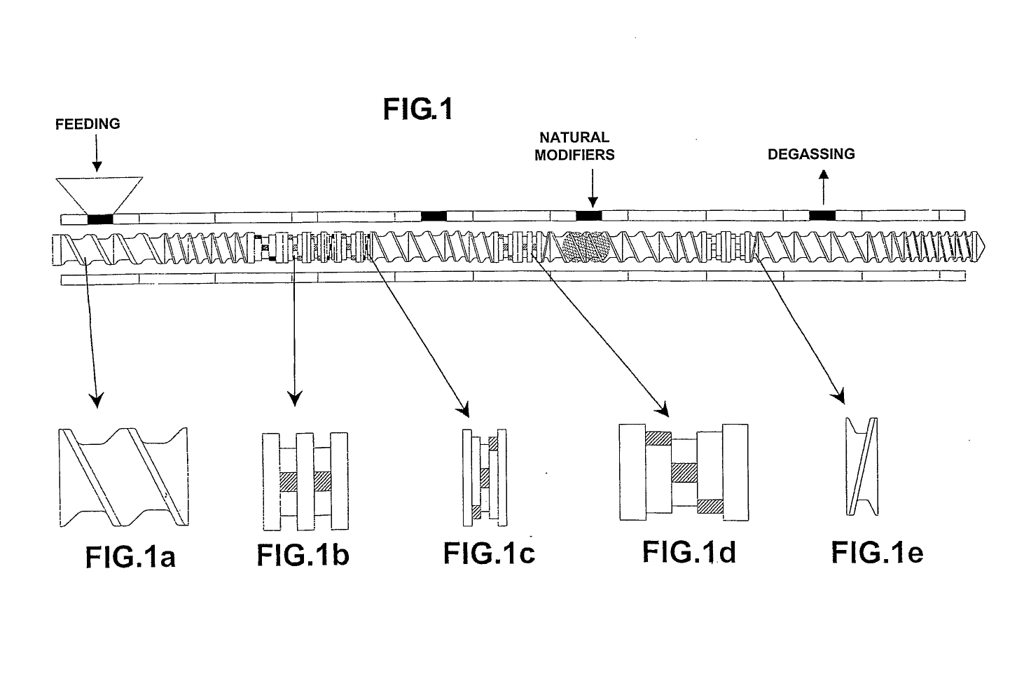

The poly(hydroxybutyrate)-PHB is the main member of the class of the polyalkanoates. Its great importance is justified by the combination of 3 important factors: it is 100% biodegradable, it is water-resistant and it is a thermoplastic polymer, enabling the same applications as conventional thermoplastic polymers. FIG. 1 presents the structural formula of the PHB.

Structural formula of the (a) 3-hydroxybutyric acid and (b) Poly (3-hydroxybutyric acid)-PHB.

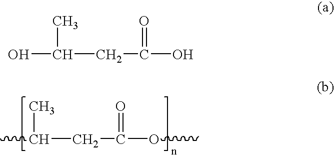

PHB was discovered by Lemognie in 1925 as a source of energy and of carbon storage in microorganisms, as in the bacteria Alcaligenis euterophus, in which, under optimal conditions, above 80% of the dry weight is of PHB. Nowadays, the bacterial fermentation is the main source of production of the poly (hydroxybutyrate), in which the bacteria are fed in reactors with butyric acid or fructose and left to grow, and the bacterial cells will be later extracted from PHB with an adequate solvent.

In Brazil, PHB is industrially produced by PHB Industrial S/A, the only Latin America Company that produces poly-hydroxyalkanoates (PHAs) from renewable sources. The production process of the poly (hydroxybutyrate) is basically constituted of two steps:

fermentative step: in which the microorganisms metabolize the sugar available in the medium and accumulate the PHB in the interior of the cell as source of reserve;

extracting step: in which the polymer accumulated in the interior of the cell of the microorganism is extracted and purified until the obtention of the product, in solid and dry state.

The project developed by PHB Industrial S.A. permitted to utilize sugar and/or molasse as basic constituents of the fermentative medium, fusel oil (organic solvent

byproduct of the alcohol manufacture) as extraction system of the polymer synthesized by the microorganisms, as well as permitted the use of the excess of sugarcane bagasse to produce energy (vapor generation) for these processes. This project allowed a perfect vertical integration with the maximum utilization of byproducts generated in the sugar and alcohol production, generating processes that utilize the so-called clean and ecologically correct technologies.

Through a production process similar to the PHB, it is possible to produce a semicrystalline bacterial copolymer of 3-hydroxybutyrate with random segments of 3-hydroxyvalerate, known as PHBV. The main difference between the two processes is based on the increase of proprionic acid in the fermentative medium. The quantity of proprionic acid in the bacteria feeding is responsible for controlling the hydroxyvalerate-HV concentration in the copolymer, enabling to vary the degradation time (which can be from some weeks to several years) and certain physical properties (molar mass, degree of crystallinity, surface area, for example). The composition of the copolymer further influences the melting point (which can range from 120 to 180° C.), and the characteristics of ductility and flexibility (which are improved with the increase of PHV concentration). FIG. 2 presents a basic structure of the PHBV.

### Basic Structure of the PHBV.

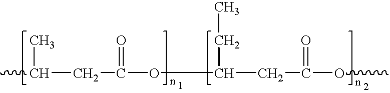

According to some studies, the PHB shows a behavior with some ductility and maximum elongation of 15%, tension elastic modulus of 1.4 GPa and notched IZOD impact strength of 50 J/m soon after the injection of the specimens. Such properties modify with time and stabilize in about one month, with the elongation reducing from 15% to 5% after 15 days of storage, reflecting the fragility of the material. The tension elastic modulus increases from 1.4 GPa to 3 GPa, while the impact strength reduces from 50 J/m to 25 J/m after the same period of storage. Table 1 presents some properties of the PHB compared to the Isostatic Polypropylene (commercial Polypropylene).

The degradation rates of the articles made of PHB or its Poly ( 3-hydroxybutyric-co-hydroxyvaleric acid)-PHBV copolymers, under several environmental conditions, are of great relevance for the user of these articles. The reason that makes them acceptable as potential biodegradable substitutes for the synthetic polymers is their complete biodegradability in aerobic and anaerobic environments to produce CO₂/H₂O/biomass and CO₂/H₂O/CH₄/biomass, respectively, through natural biological mineralization. This biodegradation usually occurs via surface attack by bacteria, fungi and algae. The actual degradation time of the biodegradable polymers and, therefore, of the PHB and PHBV, will depend upon the surrounding environment, as well as upon the thickness of the articles.

TABLE 1
Comparison of the PHB and the PP properties.

| | PHB | PP |
|---|---|---|
| Degree of crystallinity (%) | 80 | 70 |
| Average Molar mass (g/mol) | 4 × 10⁵ | 2 × 10⁵ |
| Melting Temperature (° C.) | 175 | 176 |
| Glass Transition | −5 | −10 |
| Temperature (° C.) | | |
| Density (g/cm³) | 1.2 | 0.905 |
| Modulus of Flexibility | 1.4-3.5 | 1.7 |
| (GPa) | | |
| Tensile strength (MPa) | 15-40 | 38 |
| Elongation at break (%) | 4-10 | 400 |
| UV Resistance | good | poor |
| Solvent Resistance | poor | good |

### Plasticizers

The PHB or the PHBV may or may not contain plasticizers of natural origin, specifically developed to plasticize these biodegradable polymers. Plasticizers are the most important class of additives for modifying the PHB, since they are responsible for the most significant changes in this polymer. These products are also utilized in a much higher quantity than in any other additive (from about 5 to 20%), significantly contributing to the end product cost. In general, the plasticizer stays in the polymer chains, impairing its crystallization. In the specific case of the PHB, this lower crystallization rate contributes to reduce the processing temperature of the material, reducing its thermal degradation. The lower crystallinity further contributes to a higher flexibility of the chains, making the Poly (hydroxybutyrate) - PHB less rigid and less fragile. In general, the plasticizers present a maximum concentration that can be used in the PHB. Concentrations above this limit results in exsudation of the excess product, jeopardizing the operations of surface finishing, including printing on the product. The plasticizer additive can be a vegetable oil “in natura” (as found in nature) or its ester or epoxi derivative, coming from soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and possible hydrogenated derivatives thereof, present in the composition in a mass proportion lying from about 2% to 30%, preferably from about 2% to about 15%, and more preferably from about 5% to about 10%.

Said plasticizer further presents a fatty composition varying from: 45-63% of linoleates, 2-4% of linolenates, 1-4% of palmitates, 1-3% of palmitoleates, 12-29% of oleates, 5-12% of stearates, 2-6% of miristates, 20-35% of palmistates, 1-2% of gadoleates e 0.5-1.6% of behenates.

### Other Biodegradable Polymers

The polymeric matrices of the compounds can be formed by the homopolymer PHB, by the PHBV copolymers or by polymeric blends of PHB/other biodegradable polymers. The biodegradable polymers that can form blends with the PHB are: Poly (lactic acid)-PLA, aliphatic-aromatic Copolyesters and Polycaprolactone-PCL, present in the composition in a mass proportion lying from about 5% to about 50%, and more preferably from about 10% to about 30%.

Poly (lactic acid)-PLA

The poly (lactic acid) or polylactate-PLA has been attracting attention in the last years due to its biocompatibility with fabrics, in vitro and in vivo degradability and good mechanical properties. This product is commercialized by NatureWorks LLC under the trademark “NatureWorks-PLA”. In Table 2 below, there are presented some PLA properties of interest, compared with the poly (ethylene terephthalate)-PET properties.

TABLE 2
Comparison of PLA and PET properties.

| | PET | PLA |
|---|---|---|
| Inflammability | burn 6 minutes | burn 2 minutes |
| | after removal form | after removal form |
| | the flame | the flame |
| Resilience | 51% of recuperation | 64% of recuperation |
| | with 10% of | with 10% of |
| | deformation | deformation |
| Coating | poor | good |
| Gloss | Medium up to low | Very high up to low |
| Wrinkling | good | Excellent |
| resistance | | |
| Density | 1.34 g/cm³ | 1.25 g/cm³ |

The PLA is not a polymer of recent discovery: Carothers produced a low molecular weight product by vacuum heating the lactic acid. Nowadays, this material is produced by several industries from cornstarch.

The mixture of poly (lactic acid) with poly (glycolic acid)-PGA was the first tentative to commercially use of this material. With trademark Vicryl® this polymeric mixture was developed to be used in surgical sutures. Nowadays, the PLA is utilized not only in the medical field (prostheses, implants, sutures and lozenges), but also in textile area and manufacture of products in general.

As already mentioned above, the PLA has good biocompatibility and excellent mechanical properties. Nevertheless, one of the main disadvantages of the PLA is its transition from a ductile material to a fragile material under stress due to the physical action. Thus, several polymeric mixtures with the poly-(lactic acid) were studied, in order to improve their properties and processability. Among these, one of the most preeminent polymeric blends is the mixture of the poly (lactic acid) with the poly (hydroxybutyrate)-PHB.

### Poly(Butylene Adipate/Butylene Terephthalate)

The poly (butylene adipate/butylene terephthalate) is a completely biodegradable polymer of the aliphatic-aromatic copolyester type, which is commercialized by BASF AG., under the trademark “Ecoflex®”. It is useful for garbage bags or packages. The poly (butylene adipate/butylene terephthalate) decomposes in the soil or becomes composted within weeks, without leaving any residues. BASF introduced this thermoplastic polymer in the market in 1998, and after eight years, it has become a biodegradable synthetic material commercially available worldwide. When mixed with other degradable materials based on renewable resources, such as PHB, the poly (butylene adipate/butylene terephthalate) is highly satisfactory for producing food packages and, particularly, for packaging food to be frozen. Formula 3 shows the representation of the chemical structure of the poly (butylene adipate/butylene terephthalate) copolyester, where M indicates the modular components which work as chain extenders.

Chemical structure of the polymers that form the macromolecules of the poly (butylene adipate/butylene terephthalate) aliphatic-aromatic copolyester.

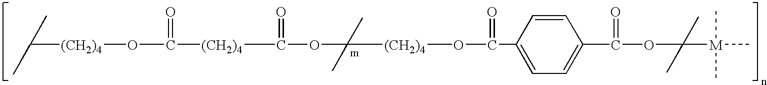

The poly (butylene adipate/butylene terephthalate) has adequate qualities for food packages, since it retains the freshness, taste and aroma in hamburger boxes, snack trays, disposable coffee cups, packages for meat or fruit and fast-food packages. The poly (butylene adipate/butylene terephthalate) improves the performance of these products, complying with the food legislation requirements.

The poly (butylene adipate/butylene terephthalate) is water-resistant, tear-resistant, flexible, allows printing thereon and can be thermowelded. In combinations with other biodegradable polymers, the polymeric blends have the advantage of being composted, presenting no problems.

### Polycaprolactone-PCL

The polycaprolactone-PCL is an aliphatic, synthetic, biodegradable polymer, and a tough, flexible and crystalline polymer, which is commercialized by Solvay Caprolactones under the trademark “CAPA”.

The chemical structure of the PCL

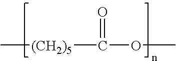

The PCL is synthetically prepared, generally by ring-opening polymerization of the E-caprolactone. The PCL has low glass transition temperature (from −60 to −70° C.) and melting temperature (58-60° C.). The slow crystallization rate causes variation in the crystallinity with time. Until recently, the PCL has not been employed in significant quantities for applications as a biodegradable polymer, due to the high cost thereof. Recently, these cost barriers have been overcome by mixing the PCL with other biodegradable polymers and/or other products, such as starch and wood flour.

The polycaprolactone is degraded by fungi, and such biodegradation occurs in two stages: a first step of abiotic hydrolytic scission of the chains of high molar mass, with the subsequent enzymatic degradation, for microbial assimilation.

Due to its low melting temperature, the pure PCL is of difficult processability. Nevertheless, its facility to increase the molecular mobility in the polymeric chain makes its use as plasticizer possible. Its biocompatibility and its “in vivo” degradation (much slower than other polyesters), also enable its use in the medical field for systems of long periods of time (from 1 to 2 years). Although it is not produced from raw material of renewable sources, the PCL is completely biodegradable, either pure or composted with biodegradable materials.

PCL blends with other biodegradable polymers are also of potential use in medical field, such as for example the PHB/PCL blends.

The polycaprolactone-PCL has been also widely studied as a substrate for biodegradation and as a matrix in the controlled drug delivery systems.

### Natural Fibers

The natural fibers are those found in nature and utilized “in natura” (as found in nature) or after its beneficiation. The natural fibers are divided, in relation to their origin, in: mineral, animal and vegetable fibers.

In the developed process natural fibers of vegetable origin are utilized, as a function of the wide variety of possible plants to be researched, and for the fact of being an inexhaustible source of natural resource.

Natural vegetable fibers, which can be merely designated as natural fibers, are found practically in all the regions of the world, under different forms of vegetation. Particularly in Brazil, there is a wide variety of natural vegetable fibers with different chemical, physical and mechanical properties.

Some fibers spontaneously occur in nature and/or are cultivated as an agricultural activity. The natural fibers can also be denominated cellulosic fibers, since the cellulose is its main chemical component, or also as lignocellulosic fibers, considering that the majority of the fibers contain lignin, which is a natural polyphenolic polymer.

The processing of thermoplastic compounds modified with natural fibers is highly complex due to the hygroscopic and hydrophylic nature of the lignocellulosic fibers. The tendency of the lignocellulosic fibers to absorb humidity will generate the formation of gases during the processing. For articles molded by the injection process, the formation of gases will bring problems, because the volatile gases remain imprisoned within the cavity during the injection molding cycle. If the material is not adequately dried before the processing, there will occur the formation of a product with porosity and with microstructure similar to a structural expanded material. This distribution of porosity is influenced by the processing conditions (pressure, time and temperature) and, consequently, will jeopardize the mechanical properties of the modified material. The presence of the absorbed water can also aggravate the thermal degradation of the cellulosic material. The hydrolytic degradation, which is enhanced when the melted polymer temperature reaches 200° C., is accompanied by the release of volatile substances. Several additional techniques have been suggested to improve the properties of the polymers modified with lignocellulosic fibers. The addition of processing aids, such as calcium stearate and polyethylene waxes, and compatibilizers as functionalized polymers, facilitates the processability and/or introduces higher polarity in the polymeric compound, promoting higher dispersibility of the lignocellulosic fibers. The natural fibers which can be utilized in the developed process are: sisal, sugarcane bagasse, coconut, piasaba, soybean, jute, ramie and curaua (Ananas lucidus), present in the composition in a mass proportion lying from about 5% to about 70%, and more preferably, from about 10% to about 60%.

The lignocellulosic fillers optionally utilized in conjunction with the natural fibers are: wood flour (or wood dust), starches and rice husk, present in the composition in a mass proportion lying from about 5% to about 70%, and more preferably, from about 10% to about 60%.

The natural fibers and the lignocellulosic fillers are employed in mass contents from 10% to 60%, being added separately or mixed together in different proportions and, in this last case, generating countless hybrid compounds, such as for example, PHB/sisal fiber/wood flour and PHB/sugarcane bagasse fiber/wood flour.

The natural fibers must be short, medium-short and medium, with length varying from 2 mm to 6 mm. The longer fibers must have their sizes reduced by a special cutting process.

Lignocellulosic fillers, Compatibilizer, surface treatment agents and Other Additives

Lignocellulosic fillers:

The wood residues, commercially known as wood flour or wood dust, even after micronization maintain a fibrous aspect (irregular texture containing short fibers), in the microscopic observation. The medium size of wood dust particles was represented by three main situations: fine −100 mesh, medium −60 mesh and thick −20 mesh).

Rice straw (or rice husk).

Starches (of corn, of manioc and of potato)

Compatibilizer, present in the composition in a mass proportion lying from about 0.01% to about 2% and, preferably, from about 0.05% to about 1% and, more preferably, from about 0.1% to about 0.5%.

Polyolefines functionalized (or grafted) with maleic anhydride—Melt Flow Index—MFI (ASTM D1238, 230° C/2.160 g): 50 g/10 min.

Ionomers based on ethylene acrylic acid or ethylene methacrylic acid copolymers, neutralized with sodium (trademark Surlin from DuPont)

Surface treatment agent: optional use of silane, titanate, zirconate, epoxy resin, stearic acid and calcium stearate for previous treatment of the natural fibers and of the natural fillers; treatment carried out in high rotation mixers, with slight heating, and with subsequent drying, neutralization and purification, present in the composition in a mass proportion lying from about 0,01% to about 2% and, preferably, from about 0,05% to about 1% and, more preferably, from about 0,1% to about 0,5%.

Processing aid/dispersant: optional utilization of processing aid/dispersant specific for compositions with thermoplastics, in the quantity of 1% in relation to the total content of modifiers; for PHB/wood dust compositions the commercial product Struktol is added, in the quantity of 1% in relation to the total content of wood dust. The processing aid, is present in the composition, in a mass proportion lying from about 0.01% to about 2% and, preferably, from about 0.05% to about 1% and, more preferably, from about 0.1% to about 0.5%.

Other additives of optional use: thermal stabilizers—primary antioxidant and secondary antioxidant, pigments, ultraviolet stabilizers of the oligomeric HALS type (sterically hindered amine), present in the composition in a mass proportion lying from about 0.01% to about 2% and, preferably, from about 0.05% to about 1% and, more preferably, from about 0.1% to about 0.5%.

### Process of Producing the Compounds Developed Methodology and Formulations of the Compounds

The generalized methodology developed for the preparation of the PHB/natural modifiers compounds is based on seven steps, which can be compulsory or not, depending upon the specific objective desired for a particular tailored material.

The steps for preparing the compounds are:

a. Defining the formulations of the compounds

b. Uniformization of the length of the natural fibers

c. Surface treatment of the natural fibers and/or of the natural fillers

d. Drying the compounds components

e. Pre-mixing the compounds components

f. Extruding and granulating

g. Injection molding for the manufacture of several products

### Description of the Steps

a. Defining the formulations of the compounds Table 3 presents the main formulations of the PHB/natural modifiers polymeric compositions.

TABLE 3
Formulations of the PHB/natural
modifiers polymeric compositions

| | CONTENT RANGE |
|---|---|
| COMPONENTS | (% IN MASS) |
| PHB or PHBV, containing or not up to | 40 to 90% |
| 6% of plasticizer of natural origin | |
| Biodegradable polymers: Copolyesters | 0 to 30% |
| or Poly (lactic acid) - PLA or | |
| Polycaprolactone - PCL* | |
| Compatibilizer - Polyolefine | 0 to 2%, in |
| functionalized with maleic anhydride | relation to the |
| or Ionomer | total content of |
| | PHB or PHBV |
| Natural fiber 1** | 0 to 60% |
| Natural fiber 2*** | |
| Lignocellulosic filler**** | 0 to 60% |
| Processing aid/Dispersant/Nucleant | 0 to 0.5% |
| Thermal stabilization system - | 0 to 0.3% |
| Primary antioxidant:secondary | |
| antioxidant (1:2) | |
| Pigments | 0 a 2.0% |
| Ultraviolet stabilizers | 0 a 2.0% |

*in case the polymeric matrix is a polymeric blend of PHB with other biodegradable polymers.
**sisal, or sugarcane bagasse, or coconut, or piasaba, or soybean, or jute, or ramie, or curaua (Ananas lucidus).
***any of the natural fibers employed, except the fiber selected as natural fiber 1.
****wood flour, starches or rice husk (or straw).

b. Uniformization of the length of the natural fibers

For the natural fibers commercially supplied with a higher length than desired, it is necessary to uniformize the size, this operation being carried out in a hammer mill with adequate set of knives and operating in a controlled speed to avoid forming undesirable fines in the production of the composite granules.

In order to adequately employ the developed process, the natural fibers length must range from 2 mm to 6 mm.

c. Surface treatment of the natural fibers and/or of the natural fillers

In order to generate a more active interface so as to allow the transfer of mechanical efforts from the reinforcement natural fiber for the polymeric matrix, when desirable, it is possible to effect the treatment of the natural fibers and of the natural fillers. The surface treatment is applied in the content of 1% of the treatment agent in relation to the natural fiber mass, the efficiency of the treatment being evaluated by quantitative techniques of surface analysis and/or by the performance of the compounds. The selection of the class of the surface treatment agent is made in each case. Within each class of surface treatment agent, specific agents are employed: silanes (diamine silanes, methacrylate silanes, styirilamine cationic silanes, epoxy silanes, vinyl silanes and chloroalkyl silanes); titanates (monoalkoxy, chelates, coordenats, 5 quaternary and neo-alkoxys); zirconate; different proportions of stearic acid and calcium stearate.

d. Drying the compounds components

When the natural fiber is commercialized with a higher humidity than recommended, its drying is compulsory. The drying referential condition of the natural fibers is: 24 hours, at 60° C., in oven with circulation of air.

The residual humidity content must be quantified by Thermogravimetry or by other equivalent analytical technique.

e. Pre-mixing the compound components

The compound components, except the fiber(s), can be physically premixed and uniformized in mixers of low rotation, at room temperature.

f. Extruding and Granulating the compounds

The extrusion process is responsible for the incorporation of the natural fibers and of the lignocellulosic fillers in the PHB polymeric matrix, as well as for the granulation of the developed material.

In the extrusion step it is necessary to use a modular co-rotating twin screw extruder with intermeshing screws, from Werner & Pfleiderer or the like, containing gravimetric feeders/dosage systems of high precision.

The main strategic aspects of both the incorporation and the distribution of the phase(s) dispersed in the polymeric matrix are: development of the profile of the modular screws considering the rheologic behavior of the polymeric material; the feeding place of the natural modifiers; the temperature profile; the extruder flowrate.

The profile of the modular screws, i.e., the type, number, distribution sequence and adequate positioning of the elements (conveying and mixing elements) determine the efficiency of the mixture and consequently the quality of the compound, without causing a processing severity that might provoke degradation of the formulation constituents.

Modular screw profiles were used with pre-established formulations of conveying elements (conventional screw element 42/42 and conventional left-hand pitch screw element 20/10 LH), controlling the pressure field and kneading elements (shearing element KB 45/5/42, left-hand pitch shearing element KB 45/5/14 LH and high shearing element KB 90/5/28), for controlling the melting and the mixture—dispersion and distribution of the components (see FIG. 1). These groups of elements are vital factors to achieve an adequate morphological control of the structure, optimum dispersion and satisfactory distribution of the natural modifiers in the PHB. The extrusion must be conducted in a way as to provide a minimum reduction in the length of the natural fibers, to achieve a maximum efficiency in the reinforcement of the material, since the physicomechanical performance is a direct function of aspect-ratio (length/diameter ratio of the natural fiber).

The natural fibers are directly introduced in the feed hopper of the extruder and/or in an intermediary position (fifth barrel), with the polymeric matrix (see FIG. 1) already in the melted state.

The temperature profile of the different heating zones, notably the feeding region and the head region at the outlet of the extruder, as well as the flowrate controlled by the rotation speed of the screws are also highly important variables.

Table 4 presents the processing conditions through extrusion for the PHB/natural modifiers polymeric compositions.

The granulation for obtaining the granules of the compounds is carried out in common granulators, which however can allow an adequate control of the speed and number of blades so that the granules present dimensions which allow achieving a high productivity in the injection molding.

TABLE 4
Extrusion conditions of the PHB/ natural modifiers
compositions

| | Temperature (° C.) | | | | | | | |
|---|---|---|---|---|---|---|---|---|
| | Zone | Zone | Zone | Zone | Zone | Zone | | Speed |
| | 1 | 2 | 4 | 5 | 6 | 7 | Head | (rpm) |
| PHB- | 110- | 125- | 150- | 165- | 165- | 165- | 175 | 140-200 |
| natural | 130 | 140 | 170 | 175 | 175 | 175 | | |
| modifiers | | | | | | | | |
| Compound | | | | | | | | |

g. Injection molding for the manufacture of several products

In the injection molding it is necessary the utilization of an injecting machine operated through a computer system to effect a strict control on the critical variables of this processing method.

Table 5 presents the processing conditions through injection for the PHB/natural modifiers polymeric compositions.

The integration of the injection molding in the developed process is satisfactorily obtained by controlling the critical variables: melt temperature, screw speed during the dosage and counter pressure. If there is not a severe control of said variables (conditions presented in Table 4), the high shearing inside the gun will give rise to the formation of gases, hindering the uniformization of the dosage, jeopardizing the filling operation of the cavities.

Special attention should also be given to the project of the molds, mainly relative to the dimensional aspect, when using the molds with hot chambers, in order to maintain the compound in the ideal temperature, and when using submarine channels, as a function of the high shearing resulting from the restricted passage to the cavity.

TABLE 5
Injection conditions of the PHB/natural modifiers
polymeric compositions

| | Feeding | Zone 2 | Zone 3 | Zone 4 | Zone 5 | |
|---|---|---|---|---|---|---|
| Thermal | 155-165 | 165-175 | 165-175 | 165-175 | 165-170 | ° C. |
| Profile | | | | | | |

| | PHB/natural modifiers | |
|---|---|---|
| Material | Compound | |
| Injection Pressure | 400-650 | bar |
| Injection Speed | 20-40 | cm³/s |
| Commutation | 400-600 | bar |
| Packing Pressure | 300-550 | bar |
| Packing Time | 10-15 | s |
| Dosage speed | 8-14 | m/min |
| Counter pressure | 10-20 | bar |
| Cooling time | 20-35 | s |
| Mold temperature | 20-40 | ° C. |

Examples of Properties Obtained for some PHB/Natural Modifiers Compounds

There are listed below examples of compounds based on the PHB and natural modifiers, whereas the Tables 6-10 present the characterization of these compounds:

### Example 1

### Compound with 70% PHB and 30% Wood Dust (Table 6).

### Example 2

### Compound with 50% PHB/50% Starch (Table 7).

### Example 3

### Compound with 70% PHB/30% Rice Husk (Table 8).

### Example 4

### Compound with 70% PHB/30% Sugarcane bagasse fiber (Table 9).

### Example 5

### Compound with 70% Plasticized PHB/10% Aliphatic-Aromatic Copolyester/20% Sisal Fibers (Table 10).

TABLE 6
Properties of the compound with 70% PHB/30% wood dust

| | | Test | | |
|---|---|---|---|---|
| | Property | Test method | Value | |
| 1 | Melt flow Index—MFI | ISO 1133, | 15 | g/10 min |
| | | 230° C./2.160 g | | |
| 2 | Density | ISO 1183, A | 1.24 | g/cm³ |
| 3 | Tensile strength at yield | ISO 527, 5 mm/min | 32 | MPa |
| | Tensile modulus | ISO 527, 5 mm/mim | 4.200 | MPa |
| | Elongation at break | ISO 527, 5 mm/min | 2% | |
| 5 | Izod Impact strength, | ISO 180/1A | 23 | J/m |
| | notched | | | |

TABLE 7
Properties of the compound with 50% PHB/50% starch

| | | Test | | |
|---|---|---|---|---|
| | Property | Test method | Value | |
| 1 | Melt flow Index—MFI | ISO 1133, | 25 | g/10 min |
| | | 230° C./2.160 g | | |
| 2 | Density | ISO 1183, A | 1.33 | g/cm³ |
| 3 | Tensile strength at yield | ISO 527, 5 mm/min | 13 | MPa |
| | Tensile modulus | ISO 527, 5 mm/mim | 2.500 | MPa |
| | Elongation at break | ISO 527, 5 mm/min | 1.3% | |
| 5 | Izod Impact strength, | ISO 180/1A | 16 | J/m |
| | notched | | | |

TABLE 8
Properties of the compound with 70% PHB/30% rice husk

| | | Test | | |
|---|---|---|---|---|
| | Property | Test method | Value | |
| 1 | Melt flow Index—MFI | ISO 1133, | 15 | g/10 min |
| | | 230° C./2.160 g | | |
| 2 | Density | ISO 1183, A | 1.23 | g/cm³ |
| 3 | Tensile strength at yield | ISO 527, 5 mm/min | 25 | Mpa |
| | Tensile modulus | ISO 527, 5 mm/mim | 4.000 | MPa |
| | Elongation at break | ISO 527, 5 mm/min | 2% | |
| 5 | Izod Impact strength, | ISO 180/1A | 21 | J/m |
| | notched | | | |

TABLE 9
Properties of the compound with 70%
PHB/30% sugarcane bagasse fiber

| | | Test | | |
|---|---|---|---|---|
| | Property | Test method | Value | |
| 1 | Melt flow Index—MFI | ISO 1133, | 17 | g/10 min |
| | | 230° C./2.160 g | | |
| 2 | Density | ISO 1183, A | 1.23 | g/cm³ |
| 3 | Tensile strength at yield | ISO 527, 5 mm/min | 25 | MPa |
| | Tensile modulus | ISO 527, 5 mm/mim | 4.500 | MPa |
| | Elongation at break | ISO 527, 5 mm/min | 2% | |
| 5 | Izod Impact strength, | ISO 180/1A | 40 | J/m |
| | notched | | | |

TABLE 10
Properties of the compound with 70% plasticized
PHB/10% Copolyester/20% sisal fibers

| | | Test | | |
|---|---|---|---|---|
| | Property | Test method | Value | |
| 1 | Melt flow Index—MFI | ISO 1133, | 15 | g/10 min |
| | | 230° C./2.160 g | | |
| 2 | Density | ISO 1183, A | 1.2 | g/cm³ |
| 3 | Tensile strength at yield | ISO 527, 5 mm/min | 20 | MPa |
| | Tensile modulus | ISO 527, 5 mm/mim | 3.000 | MPa |
| | Elongation at break | ISO 527, 5 mm/min | 3% | |
| 5 | Izod Impact strength, | ISO 180/1A, 23° C. | 72 | J/m |
| | notched | ISO 180/1A, −30° | 55 | J/m |
| | | C. | | |
| 6 | Heat deflection temperature | ISO 75, 0.45 MPa | 140° | C. |

### Assays of Biodegradation

There were buried, in biologically active soil, films of about 50 μm of thickness of the Poly (hydroxybutyrate)-PHB and of the compounds represented in Table 3, aiming at evaluating the biodegradability of these materials. As a result, it was detected the complete disappearance of all the films in a period of 60 days.

1. Environmentally degradable polymeric composition, characterized in that it comprises a biodegradable polymer defined by poly(hydroxybutyrate) (PHB) or copolymers thereof; at least one additional biodegradable polymer, such as poly (butylene adipate/butylene terephthalate), polycaprolactone and poly (lactic acid); and, optionally, at least one of the additives defined by: plasticizer of natural origin, such as natural fibers; natural fillers; thermal stabilizer; nucleant; compatibilizer; surface treatment agent; and processing aid.

2. Polymeric composition, as set forth in claim 1, characterized in that the plasticizer is a vegetable oil “in natura” (as found in nature) or derivative thereof, ester or epoxy, from soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, being present in the composition in a mass proportion lying from about 2% to about 30%, preferably from about 2% to about 15% and more preferably from about 5% to about 10%.

3. Polymeric composition, as set forth in claim 2, characterized in that the plasticizer has a fatty composition ranging from: 45-63% of linoleates, 2-4% of linoleinates, 1-4% of palmitates, 1-3% of palmitoleates, 12-29% of oleates, 5-12% of stearates, 2-6% of miristates, 20-35% of palmistate, 1-2% of gadoleates and 0.5-1.6% of behenates.

4. Polymeric composition, as set forth in claim 1, characterized in that the additional biodegradable polymer is present in the composition in a mass proportion lying from about 5% to about 50% and, more preferably, from about 10% to about 30%.

5. Polymeric composition, as set forth in claim 1, characterized in that the additional polymer, poly (butylene adipate/butylene terephthalate) aliphatic-aromatic copolyester, is a commercial product “Ecoflex” produced by BASF AG.

6. Polymeric composition, as set forth in claim 1, characterized in that the polycaprolactone-PCL is a commercial product “CAPA” produced by Solvay Caprolactones.

7. Polymeric composition, as set forth in claim 1, characterized in that the poly (lactic acid)-PLA , is a commercial product “NatureWorks-PLA” produced by NatureWorks LLC.

8. Polymeric composition, as set forth in claim 1, characterized in that the utilized natural fibers are selected from: sisal, sugarcane bagasse, coconut, piasaba, soybean, jute, ramie and curaua (Ananas lucidus), present in the composition in a mass proportion lying from about 5% to about 70%, and more preferably, from about 10% to about 60%.

9. Polymeric composition, as set forth in claim 1, characterized in that the utilized natural or lignocellulosic fillers are selected from: wood flour or wood dust, starches and rice husk, present in the composition in a mass proportion lying from about 5% to about 70%, and more preferably, from about 10% to about 60%.

10. Polymeric composition, as set forth in claim 1, characterized in that the compatibilizer is selected from: polyolefine functionalized or grafted with maleic anhydride; ionomer based on ethylene acrylic acid or ethylene methacrylic acid copolymers, neutralized with sodium “Surlin”, present in the composition in a mass proportion lying from about 0.01% to about 2%, preferably from about 0.05% to about 1% e, more preferably from about 0.1% to about 0.5%.

11. Polymeric composition, as set forth in claim 1, characterized in that the surface treatment agent is selected from: silane; titanate; zirconate; epoxy resin; stearic acid and calcium stearate, present in the composition in a mass proportion lying from about 0.01% to about 2%, preferably from about 0.05% to about 1% and, more preferably, from about 0.1% to about 0.5%.

12. Polymeric composition, as set forth in claim 1, characterized in that the processing aid is the commercial product “Struktol”, present in the composition in a mass proportion lying from about 0.01% to about 2%, preferably from about 0.05% to about 1% and, more preferably, from about 0.1% to about 0.5%.

13. Polymeric composition, as set forth in claim 1, characterized in that the stabilizer is selected from: primary antioxidant and secondary antioxidant, ultraviolet stabilizers of the oligomeric HALS type (sterically hindered amine), present in the composition in a mass proportion lying from about 0.01% to about 2% and, preferably, from about 0.05% to about 1% and, more preferably, from about 0.1% to about 0.5%.

14. Process for obtaining the environmentally degradable polymeric composition, formed by poly(hydroxybutyrate) or copolymers thereof; and at least one additional polymer, such as poly(butylene adipate/butylene terephthalate) aliphatic-aromatic copolyester; or polycaprolactone (PCL) and, optionally, at least one additive defined by: plasticizer of natural origin, such as natural fibers; natural fillers; thermal stabilizer; nucleant; compatibilizer; surface treatment agent; and processing aid, characterized in that it comprises the steps of:
a) pre-mixing the materials that constitute the composition of interest to uniformize the length of the natural fibers, the surface treatment of the natural fibers and/or of the natural fillers;
b) drying said premixed materials and extruding them, so as to obtain the granulation thereof; and
c) injection molding the extruded and granulated material for manufacture of several products.

15. Application of the environmentally degradable polymeric composition, as defined in any one of claims 1-14, in the manufacture of injected packages for food products, injected packages for cosmetics, tubes, technical pieces and several injected products.
